(19) United States
(12) Patent Application Publication
(10) Pub. No.: US 2026/0030436 A1
(43) Pub. Date: Jan. 29, 2026

(54) INFORMATION PROCESSING METHOD, INFORMATION PROCESSING APPARATUS, AND INFORMATION PROCESSING PROGRAM

(71) Applicant: LegalOn Technologies, Inc., Tokyo (JP)

(72) Inventors: Manabu NAKANO, Tokyo (JP); Yuta KURODA, Tokyo (JP)

(21) Appl. No.: 19/344,361

(22) Filed: Sep. 29, 2025

Related U.S. Application Data
(63) Continuation of application No. PCT/JP2023/013737, filed on Mar. 31, 2023.

(51) Int. Cl. G06F 40/166; G06F 40/143; G06F 40/197

(52) U.S. Cl. CPC G06F 40/166; G06F 40/143; G06F 40/197

(57) ABSTRACT

An information processing method according to an embodiment includes: acquiring first document data configured in a predetermined file format from a user terminal via a network; extracting a first data group (DEI group) necessary for editing processing and a second data group (DRI group) unnecessary for the editing processing from the first document data; executing the editing processing using the first data group; and generating second document data configured in the predetermined file format using the edited first data group and the second data group.

### CROSS-REFERENCE TO RELATED APPLICATIONS

This application claims the benefit of International Application No. PCT/JP2023/013737, filed on Mar. 31, 2023, which is hereby incorporated by reference in its entirety. This application is a bypass continuation of the aforementioned international application.

### TECHNICAL FIELD

Embodiments of the present disclosure may relate to an information processing method, an information processing apparatus, and an information processing program.

### BACKGROUND

Online editors are document creation support tools used when creating/editing a document, for example, on a web browser.

### SUMMARY

An information processing method according to an embodiment includes: acquiring first document data configured in a predetermined file format from a user terminal via a network; extracting a first data group necessary for editing processing and a second data group unnecessary for the editing processing from the first document data; executing the editing processing using the first data group; and generating second document data configured in the predetermined file format using the edited first data group and the second data group.

### BRIEF DESCRIPTION OF THE DRAWINGS

FIG. 1 is a schematic diagram for describing an outline of a document creation support system according to an embodiment.

FIG. 2 is a block diagram illustrating an example of a hardware configuration of an information processing apparatus according to the embodiment.

FIG. 3 is a diagram illustrating an example of functional blocks in a processor of the information processing apparatus of the embodiment.

FIG. 4 is a conceptual diagram for describing editing conversion processing and inverse editing conversion processing executed by the information processing apparatus of the embodiment.

FIG. 5 is a block diagram illustrating an example of a hardware configuration of a terminal apparatus according to the embodiment.

FIG. 6 is a diagram illustrating an example of functional blocks in a processor of the terminal apparatus of the embodiment.

FIG. 7 is a flowchart illustrating an example of a flow of editing processing according to the embodiment.

FIG. 8 is a flowchart illustrating an example of a flow of editing conversion processing executed by a conversion processing unit according to the embodiment.

FIG. 9 is a flowchart illustrating an example of a flow of inverse editing conversion processing executed by the conversion processing unit according to the embodiment.

### DESCRIPTION

Hereinafter, embodiments will be described in detail with reference to the drawings. Note that, in the following description, components having substantially the same functions and configurations are denoted by the same reference numerals, and description will be made when necessary. In addition, the embodiment can be combined with other embodiments, modifications, and conventional techniques.

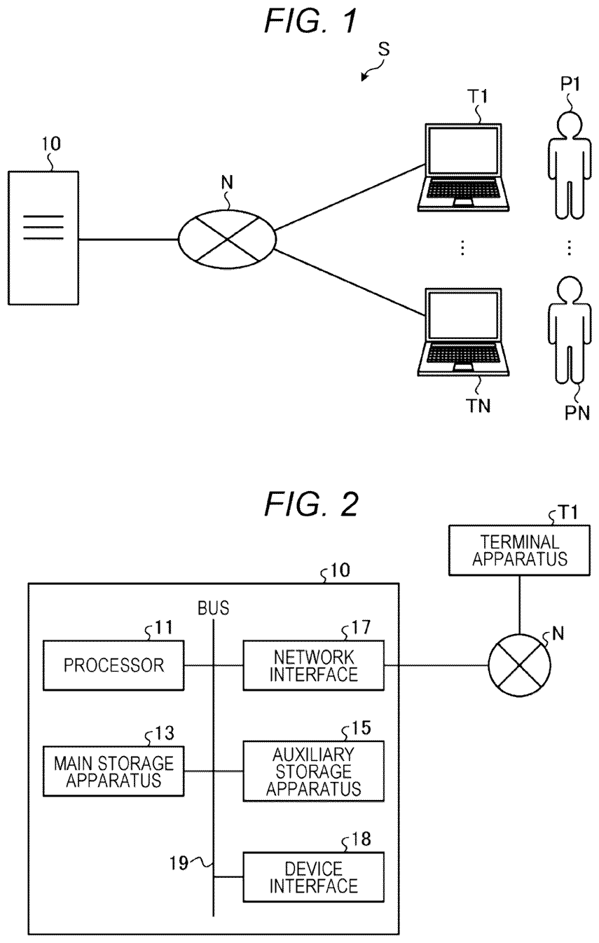

FIG. 1 is a schematic diagram for describing an outline of a document creation support system S according to the present embodiment. As illustrated in FIG. 1, the document creation support system S may function as a document creation support system, and include, for example, an information processing apparatus 10 according to the embodiment, and at least one terminal apparatus T1 to TN that can communicate with the information processing apparatus 10 via a network N. The terminal apparatuses T1 to TN may be operated by users P1 to PN, respectively. Note that the terminal apparatuses T1 to TN will be described by taking the configuration of the terminal apparatus T1 as an example.

In a conventional document edited using the online editor, unique information such as a binary file such as an image and a configuration file such as character spacing unnecessary for editing processing may exist. When a new document is created by editing with an online editor, such unique information may be missing. An object to be achieved by the present disclosure is to provide a technique capable of creating more appropriate document data than before and providing the document data to a user in document creation support using an online editor.

Here, the document creation support system S is a system that supports document creation on a browser. In the present specification, the document may mean documents in any languages created according to certain rules or standards such as certain regulations, laws, and conventions. In the present specification, document data may mean information obtained by converting a document into data in an editable manner using document creation software regardless of a data format. The document data may be typically text data, but may also include data such as image data or tabular data. In addition, the document or document data may include meta information (version, creation date, update date, creator, updater, or the like), format information (decoration such as underline and marker, font, indent, and the like), change history information, comment information, and the like created by document creation software as necessary.

Hereinafter, for the sake of specific description, a case where the document handled by the document creation support system S is a legal document (for example, an agreement) in Japanese will be described as an example. However, the document handled by the document creation support system S is not limited to agreements, and is not limited to Japanese documents. For example, it may be company regulations in English.

In the present specification, the document creation support service may be a service including at least any of executing document review processing on a support target document on a web browser and providing a result thereof to a user, executing document editing in response to an instruction from the user, saving an edited document or providing the edited document to the user, editing additional information (for example, meta information, comment information, chat information, format information, and the like) associated with the support target document, creating a new document (including a copy), comparing a plurality of documents (for example, clearly indicating difference information), and automatically proofreading the support target document.

In particular, in a case where a support target document may be edited and saved as a predetermined file format (for example, DOCX format), the document creation support system S according to the present embodiment may create appropriate document data with less missing data than before and provide the document data to the user.

In addition, in the present specification, the document review processing may be processing of analyzing or evaluating information included in a support target document based on certain standards and outputting a result thereof. For example, the document review processing may be processing including checking and examining whether or not information included in the support target document is appropriate based on certain standards. Specifically, it may include collating wording in the document with a prepared check list, and outputting a result of the collation or an indication included in the check list. In addition, editing may mean adding, deleting, or changing information included in an editing target.

The meta information associated with the support target document may include at least one of a document ID, a type (for example, a type such as a basic transaction contract, a confidentiality contract, a service contract) of the document, a version, a creation date and time, an update date and time, and an upload date and time, a creator, an updater, a deadline, and a document ID of a related document.

The comment information associated with the support target document of the present embodiment may be, for example, additional information created by at least one user related to creation of the document, and may be associated and managed for each version of the support target document. The comment information associated with the support target document may be information different from a comment typically created by the document creation software, and may include a comment created by the document creation software as necessary.

The chat information of the present embodiment may be additional information generated by using a chat function for the support target document among a plurality of users related to creation of the support target document, and may be managed in association with, for example, a plurality of versions of the support target document. These pieces of additional information may be typically text data, but may also include other data formats such as image, voice, or the like.

The support target document of the present embodiment may be a document file uploaded from a terminal apparatus, may be a file newly created on an online editor, or may be a file already uploaded and saved or/and edited.

The terminal apparatus T1 may be a client apparatus managed by the user P1 who uses the document creation support service. The terminal apparatus T1 may display a document review result and editing data on a screen of a display apparatus while associating in position the document review result and editing data with each other based on the information from the information processing apparatus 10. In the present embodiment, the user can perform operations such as indent replacement processing on the support target document, document review reference, comment input, comment reference, chat information input, chat information reference, editing processing, and document saving by using the document review result and an editing screen displayed on the screen of the display apparatus of the terminal apparatus T1.

Next, specific configurations of the information processing apparatus 10 and the terminal apparatus T1 of the present embodiment will be described.

### (Information Processing Apparatus 10)

The information processing apparatus 10 of the present embodiment may be an apparatus that is connected to a client apparatus by communication and performs various types of processing in response to a request from the client apparatus. For example, it may be a server apparatus managed by a provider side that provides a document creation support service. The information processing apparatus 10 may provide a document creation support service to the terminal apparatus T1 in response to a document creation support request received from the terminal apparatus T1, which is a client apparatus, via the network N. Specifically, in the document creation support service, the information processing apparatus 10 of the present embodiment may execute the editing processing on the support target document, and generate document data of a predetermined file format with less missing data than before.

FIG. 2 is a block diagram illustrating an example of a hardware configuration of the information processing apparatus 10 according to the embodiment. As illustrated in FIG. 2, the information processing apparatus 10 may be a computer, and include, as an example, a processor 11, a main storage apparatus (memory) 13, an auxiliary storage apparatus (memory) 15, a network interface 17, a device interface 18, and a bus 19 that connects the components.

In the information processing apparatus 10 illustrated in FIG. 2, the number of each component is one, but the information processing apparatus 10 may include a plurality of the same components. In addition, although one information processing apparatus 10 is illustrated in FIG. 2, software may be installed in a plurality of computers, and each of the plurality of computers may execute the same or different partial processing of the software. In this case, there may be a form of distributed computing in which each of the computers communicates via the network interface 17 or the like to execute processing. That is, the information processing apparatus 10 of the present embodiment may be configured as a system that achieves various functions described below by one or a plurality of computers executing commands stored in one or a plurality of storage apparatuses.

Various operations of the information processing apparatus 10 may be executed in parallel processing using one or a plurality of processors or using a plurality of computers via a network. In addition, various operations may be distributed to a plurality of arithmetic cores in the processor and executed in parallel processing. In addition, some or all of the processing, means, and the like of the present disclosure may be executed by at least one of a processor and a storage apparatus provided on a cloud communicable with the information processing apparatus 10 via the network. As described above, the processing of the document creation support system S of the present embodiment may be in the form of parallel computing by one or a plurality of computers.

The processor 11 may be an electronic circuit (process circuit, processing circuit, processing circuitry, central processing unit (CPU), graphics processing unit (GPU), field programmable gate array (FPGA), application specific integrated circuit (ASIC), or the like) including a control apparatus and an arithmetic apparatus of the information processing apparatus 10. In addition, the processor 11 may be a semiconductor apparatus or the like including a dedicated processing circuit. The processor 11 is not limited to an electronic circuit using an electronic logic element, and may be achieved by an optical circuit using an optical logic element. In addition, the processor 11 may include an arithmetic function based on quantum computing.

The processor 11 can perform arithmetic processing based on data or software (program) input from each apparatus or the like of the internal configuration of the information processing apparatus 10 and output an arithmetic result or a control signal to each apparatus or the like. The processor 11 may control each component constituting the information processing apparatus 10 by executing an operating system (OS), an application, or the like of the information processing apparatus 10.

The information processing apparatus 10 of the present embodiment may be achieved by one or a plurality of processors 11. Here, the processor 11 may refer to one or a plurality of electronic circuits disposed on one chip, or may refer to one or a plurality electronic circuits disposed on two or more chips or two or more devices. When a plurality of electronic circuits is used, the electronic circuits may communicate in a wired or wireless manner.

The main storage apparatus 13 may be a storage apparatus that stores commands executed by the processor 11, various data, and the like, and information stored in the main storage apparatus 13 may be read by the processor 11. The auxiliary storage apparatus 15 may be a storage apparatus other than the main storage apparatus 13. Note that these storage apparatuses may mean arbitrary electronic components capable of storing electronic information, and may be semiconductor memories. The semiconductor memory may be either a volatile memory or a nonvolatile memory. The storage apparatus for saving various data used in the information processing apparatus 10 according to the present embodiment may be achieved by the main storage apparatus 13 or the auxiliary storage apparatus 15, or may be achieved by a built-in memory built in the processor 11. For example, a storage unit of the present embodiment may be achieved by the main storage apparatus 13 or the auxiliary storage apparatus 15.

A plurality of processors may be connected (coupled) to one storage apparatus (memory), or a single processor 11 may be connected thereto. A plurality of storage apparatuses (memories) may be connected (coupled) to one processor. In a case where the information processing apparatus 10 of the present embodiment may include at least one storage apparatus (memory) and a plurality of processors connected (coupled) to the at least one storage apparatus (memory), at least one processor among the plurality of processors may be configured to be connected (coupled) to the at least one storage apparatus (memory). In addition, this configuration may be achieved by storage apparatuses (memories) and the processors 11 included in the plurality of computers. Further, a storage apparatus (memory) may include a configuration of being integrated with the processor 11 (for example, a cache memory including an L1 cache and an L2 cache).

The network interface 17 may be an interface for connecting to the network N wirelessly or by wire. As the network interface 17, it may be sufficient if an appropriate interface such as one conforming to an existing communication standard is used. The network interface 17 may exchange information with an external apparatus connected via the network N. Note that the network N may be any of a wide area network (WAN), a local area network (LAN), a personal area network (PAN), or the like, or may be a combination thereof, as long as information is exchanged between the information processing apparatus 10 and the external apparatus. Examples of the WAN may include the Internet, examples of the LAN may include IEEE802.11 and Ethernet (registered trademark), and examples of the PAN include Bluetooth (registered trademark) and near field communication (NFC).

The device interface 18 may be an interface such as a universal serial bus (USB) directly connected to an output apparatus such as a display apparatus, an input apparatus, and an external apparatus. In addition, the external apparatus may be a storage apparatus (memory), a network storage, a storage such as an HDD, or the like. In addition, the external apparatus may be an apparatus having some functions of the components of the information processing apparatus 10 of the present embodiment. That is, the information processing apparatus 10 may transmit or receive a part or the whole of the processing result of the external apparatus.

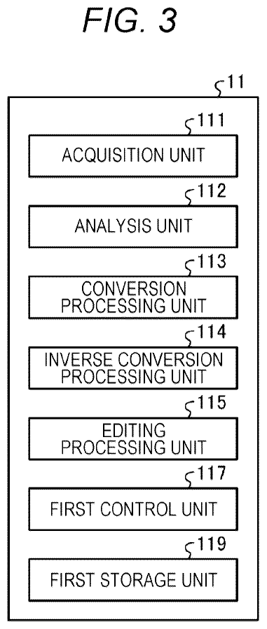

FIG. 3 is a diagram illustrating an example of functional blocks in the processor 11. The processor 11 may include, for example, an acquisition unit 111, an analysis unit 112, a conversion processing unit 113, an inverse conversion processing unit 114, an editing processing unit 115, a first control unit 117, and a first storage unit 119 as functions achieved by the processor 11. The functions achieved by the acquisition unit 111, the analysis unit 112, the conversion processing unit 113, the inverse conversion processing unit 114, the editing processing unit 115, the first control unit 117, and the first storage unit 119 may be stored as programs in, for example, the main storage apparatus 13 or the auxiliary storage apparatus 15. The processor 11 can achieve functions related to the acquisition unit 111, the analysis unit 112, the conversion processing unit 113, the inverse conversion processing unit 114, the editing processing unit 115, the first control unit 117, and the first storage unit 119 by reading and executing the programs stored in the main storage apparatus 13, the auxiliary storage apparatus 15, or the like.

The acquisition unit 111 may acquire support target document data in DOCX format (an example of first document data) via the network N. In addition, the acquisition unit 111 may acquire the support target document data in DOCX format stored in the first storage unit 119 as the support target document. In addition, the acquisition unit 111 may acquire the support target document data in DOCX format stored in the storage unit of another apparatus as the support target document via the network N.

The analysis unit 112 may execute document review processing using the support target document data received from the acquisition unit 111. That is, the analysis unit 112 may generate document review information to be described below regarding the support target document data as the document review processing. Note that the document review information is an example of analysis information.

The analysis unit 112 may extract, for example, information that is included in a document (document data) and is necessary for generating review information. Various techniques can be adopted as a method for extracting the information from the document data. For example, a keyword search of the document data may be performed to extract characters, numbers, and the like included in the vicinity of the keyword. In addition, information can be extracted by morphological analysis, syntax analysis, semantic analysis, or context analysis. Further, information may also be extracted by natural language processing using machine learning. In addition, prior to these pieces of processing, information necessary for document review such as text data may be extracted from the received document data, or processing of extracting text data from image data by processing such as OCR may be performed. Note that the document review processing may be performed on the received document without extracting information necessary for generating the document review information as described above.

The analysis unit 112 may perform document review processing and generate document review information. The document review information may be based on information obtained by analyzing the document based on rules or standards applied to the document (for example, certain rules, laws, conventions). For example, the review information of the agreement as in the present embodiment can include, for example, (1) indication as to whether the clause included in the document (the agreement in the present embodiment) is advantageous or disadvantageous to the user (party), (2) advice regarding correction or deletion of the clause included in the agreement, (3) indication of missing of an item that should be normally included in the agreement and suggestion of an item to be added, and (4) information of the importance and the degree of recommendation of the item of each review result. In addition, format information such as whether the format of a sentence meets the standard, and whether a prescribed term is used may also be included.

Note that the generation of the document review information executed by the analysis unit 112 can adopt various techniques. For example, the document review information may be generated on a rule basis using the extracted information. In addition, it is also possible to use a trained model that receives the extracted information and outputs the corresponding document review information. Further, it is also possible to adopt a combination of a rule-based method and a trained model. Note that, before the generation of the document review information, the document may be divided into units of articles/sections/items and the like.

In addition, the analysis unit 112 can also generate the document review information according to the position of the user (party) by using the meta information associated with the support target document. Further, the analysis unit 112 can also generate the document review information with reference to the contents of other documents (other versions of the support target document, other agreements related to the support target document, or the like). The meta information may include those given to a document file itself such as a creator of the document and those given by a user or the like by being input separately from the file.

The conversion processing unit 113 may execute the editing conversion processing. The editing conversion processing may be processing of extracting a first data group necessary for the editing processing and a second data group unnecessary for the editing processing from the support target document data in a predetermined file format (DOCX format in the present embodiment) received from the acquisition unit 111 and generating editing data using the first data group. Note that the editing data is an example of third document data.

The inverse conversion processing unit 114 may execute the inverse editing conversion processing. The inverse editing conversion processing may be processing of generating the first data group by inversely converting the editing data after the editing processing, associating and integrating the first data group and the second data group extracted by the conversion processing unit 113, and generating (restoring) support target document data in a predetermined file format (DOCX format in the present embodiment).

Here, the concepts of the editing conversion processing executed by the conversion processing unit 113 and the inverse editing conversion processing executed by the inverse conversion processing unit 114 will be described in detail.

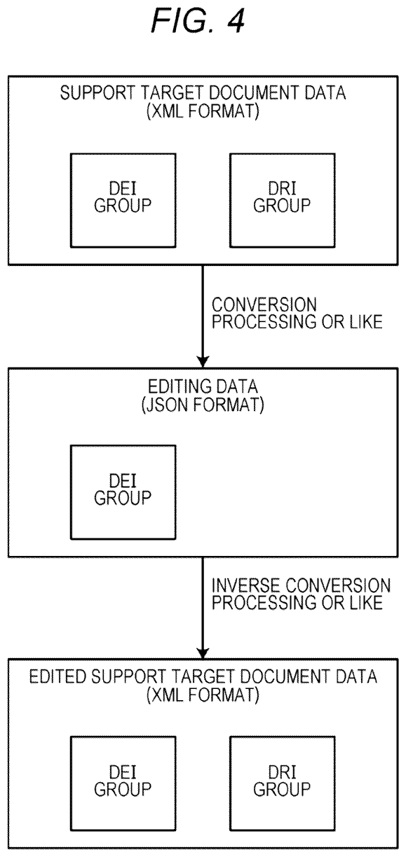

FIG. 4 is a conceptual diagram for describing the editing conversion processing and the inverse editing conversion processing. The upper part of FIG. 4 schematically illustrates an example of support target document data converted into XML format by decompressing the uploaded support target document data in DOCX format (support target document data acquired by the acquisition unit 111 from the terminal apparatus T1). The middle part of FIG. 4 schematically illustrates an example of editing data in a predetermined file format (in the embodiment, a Javascript Object Notation (JSON) format) generated using only a data group necessary for the editing processing within the support target document data converted into XML format. The lower part of FIG. 4 schematically illustrates an example of support target document data in XML format after the editing processing generated using the editing data after the editing processing and the data group unnecessary for the editing processing within the support target document data converted into XML format. The editing conversion processing may correspond to the processing from the upper part to the middle part of FIG. 4, and the inverse editing conversion processing may correspond to the processing from the middle part to the lower part of FIG. 4.

The support target document data in XML format may include a plurality of pieces of XML data such as document XML data, numbering XML data, and style XML data. The plurality of pieces of XML data can be classified into a group of information necessary for the editing processing (document editable information; hereinafter, also referred to as “DEI”) (an example of the first data group; hereinafter also referred to as “DEI group”) and a group of information unnecessary for the editing processing (document retention information; hereinafter, also referred to as “DRI”) (an example of the second data group; hereinafter also referred to as “DRI group”). The conversion processing unit 113 may extract the DEI group and the DRI group from the support target document data in XML format. Note that when the information necessary for the editing processing and the information unnecessary for the editing process may be separately classified into the first and second data groups, the data necessary for a part of the editing processing may be classified into the second data group within a range not greatly affecting the editing processing, and the information originally unnecessary for the editing processing may be classified into the first data group.

Note that examples of the DEI may include document XML data, numbering XML data, comments XML data, and comments Extended XML data. The DEI group at least may include document XML data. In addition, the DRI may be XML data other than the DEI, and examples thereof may include style XML data, header XML data, footer XML data, [trash]/HHHH.dat data, thmbbail.emf data, settings. XML data, [Content_Types].XML data, and the like.

As illustrated in the middle part of FIG. 4, the conversion processing unit 113 may perform predetermined conversion processing or the like on the DEI group to generate the editing data in JSON format. Accordingly, the editing data in JSON format may not include information derived from the DRI group. The editing processing executed in the editing processing unit 115 may be executed on the editing data in JSON format based on the DEI group. Note that the DRI group may be held (for example, saved in the first storage unit 119) without being used for the editing processing.

As illustrated in the lower part of FIG. 4, the inverse conversion processing unit 114 may perform predetermined inverse conversion processing or the like on the edited editing data in JSON format to generate (restore) the DEI group in XML format. The inverse conversion processing unit 114 may associate and combine the generated DEI group in XML format with the DRI group in XML format extracted by the conversion processing unit 113, and generate (restore) edited support target document data in XML format.

The inverse conversion processing unit 114 may compress the edited support target document data in XML format to generate edited support target document data in DOCX format. The inverse conversion processing unit 114 may save the edited support target document data in DOCX format in the first storage unit 119 or transmit the edited support target document data in DOCX format to the terminal apparatus T1. Note that the edited support target document data in DOCX format may be managed as a next version of the support target document data in DOCX format before editing, or may be managed by overwriting the support target document data in DOCX format before editing.

Note that specific processing such as the editing conversion processing executed in the editing conversion processing and the inverse conversion processing executed in the inverse editing conversion processing will be described below in detail.

Returning to FIG. 3, the editing processing unit 115 of the embodiment may execute the editing processing on the editing data in response to an editing instruction received from the terminal apparatus T1 via the acquisition unit 111 using the editing data generated by the conversion processing unit 113. Here, the editing processing executed by the editing processing unit 115 may include adding, deleting, and changing information included in the editing data. More specifically, addition, correction, and deletion of a word, a sentence, and a character decoration (for example, a font, a color of a character, a size of a character, a thickness of a character, an underline, a strikethrough, or the like) with respect to the editing data are included.

In addition, the editing processing executed by the editing processing unit 115 can include format editing processing, word input assist processing, draft suggest processing, indication item extraction processing, and difference information extraction processing.

Here, the format editing processing may be, for example, processing of correcting the format of the editing data as a document. For example, indent, the line head of a bulleted list, right-alignment/left-alignment, deviation of the clause number, and the like may be preferably automatically corrected by the system by the format editing processing. The editing processing unit 115 may refer to, for example, format information of the support target document corresponding to the editing data, and execute the format editing processing on the editing data on the basis of the format information. In addition, the setting of the format as the document may be preferably saved in the information processing apparatus 10 in advance on the basis of the type of the support target document such as an agreement. For example, in the case of a legal document such as an agreement or company regulations, the clauses may be arranged in the order of articles, sections, and items in the ascending order of the clause numbers, and the indent may be set to be larger in the order of articles, sections, and items. In addition, the editing processing unit 115 can execute the format editing processing according to the type on the basis of the meta information of the support target document. Note that this format setting may be created by the user, may be provided as part of the document creation support service, or may be created by the user customizing the provided setting. In addition, the format setting of the support target document may be interpreted, and the support target document may be created based on the interpretation.

The word input assist processing of the present embodiment may be processing of assisting input by presenting a candidate word or phrase to be input next at the time of editing the document data. As a result, it is possible to support the user's input operation at the time of editing and reduce the work load. For example, words and the like that frequently appear according to the type of the support target document can be presented as input candidates. In addition, the support target document stored by the user or an organization to which the user belongs may be analyzed, and a word or the like that is often used may be presented. In addition, the user may set a word or a phrase. The editing processing unit 115 can determine an input candidate word according to the type based on the meta information of the support target document. The word and the like presented in the input assist processing may be displayed, for example, in a left window (in a document editing window) of a screen.

The draft suggest processing of the present embodiment may be processing of displaying a draft of an input candidate at the time of editing. For example, in a case where the document is an agreement, a correction sentence example based on at least a part of the correction content of the agreement may be read from a database in which a text draft sentence example is accumulated and presented as a draft candidate. As a result, it is possible to support the user's input operation at the time of editing and reduce the work load.

The editing processing unit 115 can also present a predetermined draft candidate, may present a draft candidate determined by the user, may present a draft candidate generated by a sentence generation service in or outside the present system using a large language model (LLM) or the like, or may present a draft candidate frequently appearing according to the type of the support target document. In addition, the support target document stored by the user or an organization to which the user belongs may be analyzed, and a draft candidate that is often used than other drafts may be presented. In a case where there is a plurality of sentence example candidates, at least one draft candidate can be selected further on the basis of an adoption frequency rate of a text in the past document creation support service (a rate at which a proposed text is selected by the user) and an adoption frequency, and a candidate with a high adoption rate can be preferentially presented to the user. Note that the draft candidate to be presented can be presented as, for example, document review information or other information.

The editing processing unit 115 can also edit the editing data in response to the editing instruction based on the presented draft candidate, for example, an instruction by a drag and drop operation. The proposed draft may be displayed in a document review area or the like to be described below by being associated with the corresponding portion of the document in position. For example, the draft candidate may be displayed close to the corresponding portion of the document. With such display, the portions corresponding to the draft candidate and the document can be compared with each other with less movement of the line of sight, and the burden on the user can be reduced.

The indication item extraction processing of the present embodiment may be to extract an indication item (for example, document review information, comment information, and chat information regarding the document data corresponding to the editing data, a correction history with respect to the editing data, a comment on the document data created by the function of the document creation software, and the like) related to at least one of the editing data and the document data corresponding to the editing data, and present the indication item to the user. The editing processing unit 115 of the present embodiment may present the extracted indication item to the user in a predetermined display form. The indication item may be preferably displayed in a list in an area not overlapping with the portion of the document indicated by the indication item, for example, the document review area displayed side by side with an editing area, or an independent (individual) window such as a pop-up window.

In addition, a combination of the indication item extraction processing and the draft suggest processing may be used to propose an indication item and a draft candidate that can resolve the indication item. At this time, it may be preferable that the indication item and the draft candidate are displayed in association with the indication portion of the document in position. For example, it may be preferable that the indication item and the draft candidate are displayed close to the corresponding indication item. With such display, the portions corresponding to the indication item, the draft candidate, and the document can be compared with each other with less movement of the line of sight, and the burden on the user can be reduced.

In addition, collapse display, minimization display, display size change, and the like can be executed with respect to the document review area, the pop-up window, and the like in which the indication item and the draft candidate may be displayed. As a result, the user can arrange the document editing screen with a limited size such that the user can easily see the document editing screen, for example, while aligning the document editing screen with the portion of the indication in the document. In addition, on the basis of the height of the indication item or the draft candidate, each text may be displayed at a wider interval in the editing area. With such display, it is possible to more clearly and easily indicate the correspondence relationship between the indication item, the draft candidate, and the indication portion of the document.

The difference information extraction processing of the present embodiment may present difference information between the editing data before correction and the editing data after correction to the user. The editing processing unit 115 of the present embodiment may extract difference information from the editing data before correction and the editing data after correction, and present the difference information to the user in a predetermined display form, for example, by displaying the difference and the other portion (that is, the same portion) differently, for example, by emphasis display or highlighting.

The first control unit 117 may perform information communication with the terminal apparatus T1 via a network. Specifically, the first control unit 117 may receive the document data, and various instructions such a document review instruction, an editing instruction, and a save instruction transmitted from the terminal apparatus T1. In addition, the first control unit 117 may transmit editing screen information (including information for executing editing processing on the terminal apparatus T1 side) to the terminal apparatus T1. The first control unit 117 may receive information including the document data after the editing processing from the terminal apparatus T1.

The first control unit 117 of the present embodiment may generate layout information in the editing processing. The layout information in the editing processing may be, for example, information for displaying the generated document review information and the editing data generated by the editing processing in a predetermined form on the browser screen of the terminal apparatus T1. Further, the first control unit 117 of the present embodiment may generate layout information in the document review processing. The layout information in the document review processing may be, for example, information for displaying the document review information generated by the document review processing and the support target document in a predetermined form on the browser screen of the terminal apparatus T1.

The layout information may associate the document review information generated by the document review processing and the support target document with each other in position. Note that the association with each other in position may refer to associating display positions so as to contribute to browsing by the user, and specifically mean associating the positions on the screen, for example, in units of clauses, in units of paragraphs, and in units of sentences. Association in position may include, for example, displaying the corresponding portions closer to each other in the height or width direction than the other portions on the screen, and more preferably, displaying the corresponding portions side by side. In addition, in a case where the additional information is displayed together, the layout information may include information for associating the additional information, the document review information, and the editing data with each other in position.

The generation of the layout information may be performed by any method. For example, regarding a word and a phrase included in the document review information, the degree of matching may be scored for each position (for example, for each position in units of clauses or each position in units of paragraphs) in the editing data by a search function, and the layout information may be generated such that the document review information may be displayed corresponding to the position of the highest score. In addition, for example, by assigning coordinates in units of clauses or in units of paragraphs of the editing data and associating the coordinates with the corresponding document review information, it is also possible to associate the display positions of the clauses and the paragraphs with the document review information.

The first control unit 117 of the present embodiment may transmit various types of information such as document review information generated by the analysis unit 112, editing data generated by the editing processing unit 115, and layout information generated by the first control unit 117 in response to a request from the terminal apparatus T1.

The first storage unit 119 may store document data uploaded from the terminal apparatus T1, document data of a new version generated from the editing data by the editing processing, additional information associated with each document data, and the like.

In addition, the first storage unit 119 may store the DRI group in XML format extracted by the editing conversion processing.

### (Terminal Apparatus T1)

The terminal apparatus T1 of the present embodiment may transmit and receive information regarding document display and document editing to and from the information processing apparatus 10 in the document creation support service.

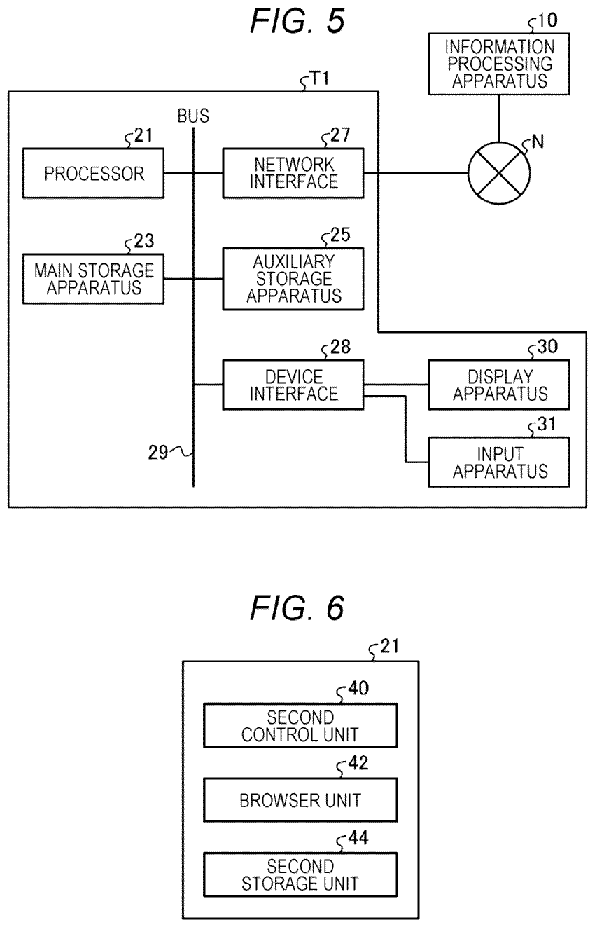

FIG. 5 is a block diagram illustrating an example of a hardware configuration of the terminal apparatus T1 according to the embodiment. As illustrated in FIG. 5, the terminal apparatus T1 may be a computer, and include, as an example, a processor 21, a main storage apparatus (memory) 23, an auxiliary storage apparatus (memory) 25, a network interface 27, a device interface 28, a bus 29 connecting the components, a display apparatus 30 connected to the device interface 28, and an input apparatus 31 connected to the device interface 28. Note that specific hardware configurations of the processor 21, the main storage apparatus 23, the auxiliary storage apparatus 25, the network interface 27, the device interface 28, and the bus 29 are similar to those of the processor 11, the main storage apparatus 13, the auxiliary storage apparatus 15, the network interface 17, the device interface 18, and the bus 19, respectively, and thus description thereof may be omitted.

The display apparatus 30 may be a display apparatus such as a liquid crystal display (LCD), a cathode ray tube (CRT), a plasma display panel (PDP), or an organic electro luminescence (EL) panel. The display apparatus 30 may display, for example, a document review screen to be described below and the document editing screen based on an instruction from the processor 21.

The input apparatus 31 may be a device such as a keyboard, a mouse, or a touch panel. The user can input various editing instructions in the editing processing described below, for example, using the input apparatus 31. The instruction input from the input apparatus 31 is sent to the processor 21.

Note that the terminal apparatus T1 may include another external apparatus (for example, a camera, a microphone, motion capture, various sensors, and the like) connected via the device interface 18 in order to operate and edit the document data.

FIG. 6 is a diagram illustrating an example of functional blocks in the processor 21. The processor 21 may include, for example, a second control unit 40, a browser unit 42, and a second storage unit 44 as functions achieved by the processor 21. The functions achieved by the second control unit 40, the browser unit 42, and the second storage unit 44 may be stored as programs in, for example, the main storage apparatus 23 or the auxiliary storage apparatus 25. The processor 21 can achieve the functions related to the second control unit 40 and the browser unit 42 by reading and executing the programs stored in the main storage apparatus 23, the auxiliary storage apparatus 25, or the like.

The second control unit 40 may activate the browser unit 42 in response to an instruction from the user.

The browser unit 42 may be, for example, a general web browser, and executes processing according to hyper text markup language (HTML) data, a script (for example, JavaScript (registered trademark)), or the like. When activated, the browser unit 42 may transmit an initial access URL to the information processing apparatus 10 to access.

The browser unit 42 of the present embodiment may display, for example, data including text data and image data received from the information processing apparatus 10 on the display apparatus 30 of the terminal apparatus T1 in a predetermined form. More specifically, in the document review processing, the browser unit 42 may display the document review information, the document data, the additional information, and the like received from the information processing apparatus 10 on the display apparatus 30 of the terminal apparatus T1 in a predetermined form based on the layout information. In addition, in the editing processing, the browser unit 42 of the present embodiment may display the document review information, the editing data, the additional information, and the like received from the information processing apparatus 10 on the display apparatus 30 of the terminal apparatus T1 in a predetermined form based on the layout information.

In addition, the browser unit 42 may transmit, for example, an editing start instruction, a document save instruction, and the like from the user to the information processing apparatus 10. For example, the browser unit 42 may receive editing screen information (including information for executing the editing processing) from the first control unit 117. The browser unit 42 may display the editing data generated by the editing conversion processing on the display apparatus 30 and executes the editing processing. The browser unit 42 may receive the support target document in DOCX format after the editing processing, and store the support target document in the second storage unit 44.

The second storage unit 44 may store, for example, the support target document in DOCX format before the editing processing and the support target document in DOCX format after the editing processing acquired by the browser unit 42.

### (Editing Processing Including Editing Conversion Processing and Inverse Editing Conversion Processing)

Next, editing processing including the editing conversion processing and the inverse editing conversion processing achieved by the present embodiment will be described.

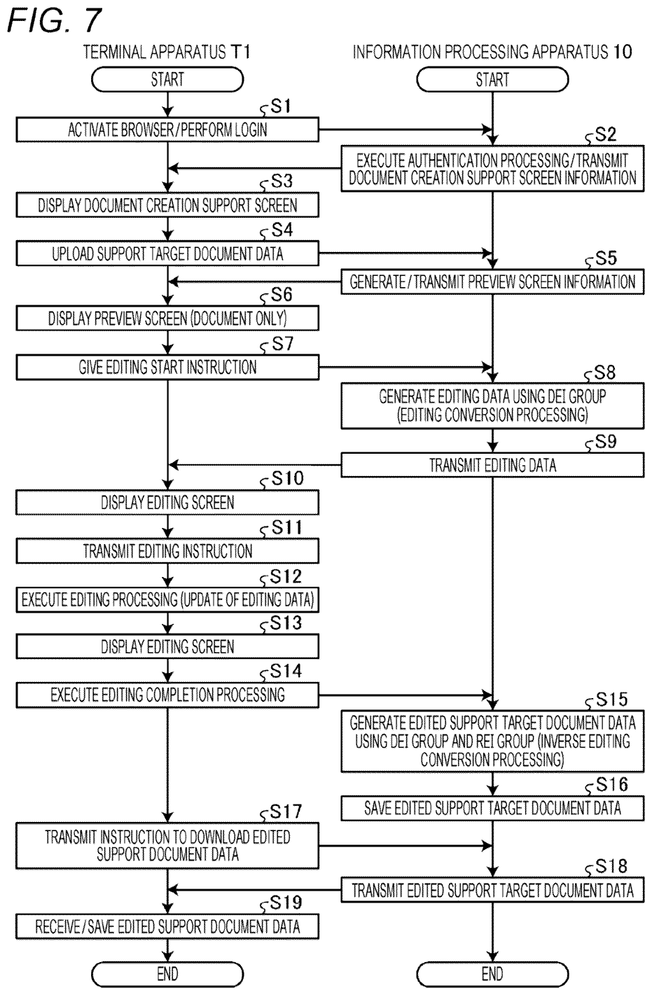

FIG. 7 is a flowchart illustrating an example of editing processing including the editing conversion processing and the inverse editing conversion processing executed by the information processing apparatus of the embodiment. First, the second control unit 40 of the terminal apparatus T1 may activate the browser unit 42 in response to an instruction from the user. The browser unit 42 of the terminal apparatus T1 may transmit the initial access URL and login information such as a registration ID to the information processing apparatus 10 (step S1).

The first control unit 117 of the information processing apparatus 10 may execute authentication processing in response to the login information from the terminal apparatus T1. In addition, the first control unit 117 may transmit document creation support screen information generated by the first control unit 117 (step S2).

The browser unit 42 of the terminal apparatus T1 may display a document creation support screen on the display apparatus 30 on the basis of the document creation support screen information received from the information processing apparatus 10 (step S3).

The browser unit 42 of the terminal apparatus T1 may transmit the support target document data in DOCX format (for example, MS-WORD data) to the information processing apparatus 10 in response to the document upload instruction from the user (step S4). Note that this upload instruction may be executed by a user who gives an editing instruction, or may be executed by a different user or/and a terminal. For example, it may be executed by a terminal of a user of another department who requests the legal department to examine the agreement.

The acquisition unit 111 of the information processing apparatus 10 may save the document data acquired (received) from the terminal apparatus T1 in the first storage unit 119. The first control unit 117 of the information processing apparatus 10 may generate document preview screen information on the basis of the document data acquired by the acquisition unit 111. The first control unit 117 of the information processing apparatus 10 may transmit the generated document preview screen information to the terminal apparatus T1 (step S5). Note that the document upload instruction and the saving of the document data in the first storage unit 119 may be performed by, for example, another user or/and another terminal of another department that requests the legal department to examine the agreement in advance of the editing processing.

The browser unit 42 of the terminal apparatus T1 may display the document preview screen on the basis of the document preview screen information received from the information processing apparatus 10 (step S6). Note that, at this stage, since it is before the document review processing, for example, only the support target document may be displayed on the document preview screen. Note that the document creation support system S of the present embodiment can be used not only for editing a document but also for browsing a document by executing step S6.

The browser unit 42 of the terminal apparatus T1 may transmit an editing start instruction input from the user to the information processing apparatus 10 (step S7).

In response to the editing start instruction from the terminal apparatus T1, the conversion processing unit 113 of the information processing apparatus 10 may execute the editing conversion processing and generate editing data (step S8).

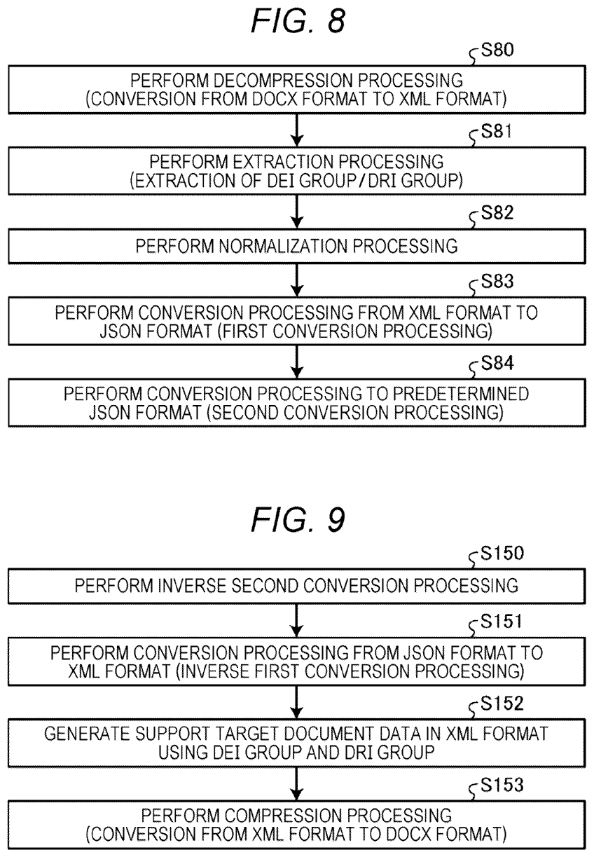

FIG. 8 is a flowchart illustrating an example of a flow of editing conversion processing achieved by the embodiment. Specific contents of the editing conversion processing will be described with reference to FIG. 8.

As illustrated in FIG. 8, the conversion processing unit 113 may decompress the document data in DOCX format acquired by the acquisition unit 111, and acquire the support target document data in XML format (step S80).

The conversion processing unit 113 may execute extraction processing of extracting the DEI group necessary for the editing processing and the DRI group unnecessary for the editing processing from the support target document data in XML format (step S81).

The conversion processing unit 113 may execute normalization processing for the extracted DEI group to satisfy the specification as XML format (step S82). Specifically, the conversion processing unit 113 may execute, as the normalization processing, processing such as adding an XML declaration to XML data that does not satisfy the specification as XML, such as without XML declaration.

The conversion processing unit 113 may execute first conversion processing of converting the DEI group from XML format to JSON format (step S83).

The conversion processing unit 113 may execute second conversion processing of converting the DEI group converted into JSON format by the first conversion processing into, for example, JSON format usable in a predetermined library, and generate editing data (step S84).

Returning to FIG. 7, the first control unit 117 of the information processing apparatus 10 may transmit the generated editing data (URL for accessing editing data, and information for executing editing processing on the terminal apparatus T1) to the terminal apparatus T1 (step S9).

The browser unit 42 of the terminal apparatus T1 may access the editing data using the URL acquired from the information processing apparatus 10, and display the document editing screen including the editing data (step S10).

The browser unit 42 of the terminal apparatus T1 may transmit an editing instruction according to the editing operation input from the user to the information processing apparatus 10 (step S11).

The browser unit 42 of the terminal apparatus T1 may execute the editing processing (update of the editing data) in response to the editing instruction from the terminal apparatus T1 (step S12). Note that, in the editing processing, example sentences (for example, an example sentence presented in the review processing) prepared in the document creation support system S can also be added to the editing data on the basis of an editing instruction.

The browser unit 42 of the terminal apparatus T1 may display the document editing screen (document after editing processing) based on the editing data after the editing processing and the editing screen information (step S13).

Note that the processing from steps S11 to S13 may be repeatedly executed every time the operator gives a desired editing instruction.

In response to the operation of an editing completion button from the user, the first control unit 117 of the information processing apparatus 10 may execute editing completion processing, and transmit an editing completion instruction to the information processing apparatus 10 (step S14). At this time, the browser unit 42 may include a universal unique identifier (uuid) in the URL acquired in step S9 in the editing completion instruction and transmit the editing completion instruction to the information processing apparatus 10.

The inverse conversion processing unit 114 of the information processing apparatus 10 may acquire a download instruction including the uuid from the terminal apparatus T1, execute the inverse editing conversion processing in response to the instruction, and generate support target document data (document data to be saved) in DOCX format (step S15).

FIG. 9 is a flowchart illustrating an example of a flow of the inverse editing conversion processing executed by the inverse conversion processing unit 114 according to the embodiment. Specific contents of the editing conversion processing executed by the inverse conversion processing unit 114 will be described with reference to FIG. 9.

As illustrated in FIG. 9, the inverse conversion processing unit 114 may execute conversion processing (inverse second conversion processing) opposite to the second conversion processing on the edited editing data to generate the DEI group in JSON format (step S150).

The inverse conversion processing unit 114 may execute inverse first conversion processing of generating the DEI group in XML format from the DEI group in JSON format (step S151).

The inverse conversion processing unit 114 may associate (integrate) the DEI group in XML format obtained by the inverse first conversion processing with the DRI group in XML format extracted in step S81, and generate document data in XML format including the DEI group and the DRI group. Note that the DRI group in XML format extracted in step S81 can be acquired using the uuid acquired in step S16 (step S152).

The inverse conversion processing unit 114 may compress the document data in XML format including the DEI group and the DRI group to generate support target document data in DOCX format (step S153).

Returning to FIG. 7, the first control unit 117 of the information processing apparatus 10 may transmit the support target document data in DOCX format after the editing processing (document data to be saved) to the terminal apparatus T1 (step S16).

In response to the operation of the download button input from the user, the browser unit 42 of the terminal apparatus T1 may transmit an instruction to download the support target document data in DOCX format after the editing processing to the information processing apparatus 10 (step S17).

The browser unit 42 of the terminal apparatus T1 may receive the support target document data in DOCX format after the editing processing from the information processing apparatus 10, and save the support target document data in the second storage unit 44 (step S18).

The first control unit 117 of the information processing apparatus 10 may save the support target document data in DOCX format after the editing processing in the first storage unit 119 (step S19).

Note that, in step S19, the support target document data in DOCX format after the editing processing may be overwritten on the support target document data in DOCX format before the editing processing uploaded in step S4. In addition, the support target document data in DOCX format before the editing processing uploaded in step S4 and the support target document data in DOCX format after the editing processing can be saved as separate data (for example, data of different versions).

Note that an URL enabling access to the edited document data may be issued without performing document data download processing. In addition, the terminal apparatus that performs download may be a terminal apparatus different from the terminal apparatus that has performed editing, and the download may be performed by a user of another department who requests the legal department to examine the agreement or the contract negotiation other party.

As described above, the information processing apparatus according to the embodiment may include the main storage apparatus 13 and the auxiliary storage apparatus 15 as at least one memory, and the processor 11 as at least one processor. The acquisition unit 111 achieved by the processor 11 may acquire the support target document data as the first document data configured in DOCX format, for example, from the terminal apparatus T1 as a user terminal via the network. The conversion processing unit 113 achieved by the processor 11 may extract the DEI group as the first data group necessary for the editing processing and the DRI group as the second data group unnecessary for the editing processing from the support target document data. The terminal apparatus T1 may execute the editing processing using the editing data based on the DEI group. The inverse conversion processing unit 114 achieved by the processor 11 may generate support target document data in XML format by using the DEI group after editing and the extracted DRI group, and convert the support target document data to generate support target document data in DOCX format as the second document data.

The support target document data in DOCX format after the editing processing may include not only the DEI group after editing but also the extracted DRI group. Accordingly, it is possible to provide the user with the support target document data in DOCX format after the editing processing without the missing of an image file or a configuration file such as character spacing, and it may be possible to prevent the occurrence of an error due to, for example, the missing of setting XML data. As a result, in the document creation support using the online editor, a more appropriate edited document than before can be created and provided to the user. In addition, the editing processing may be executed using the editing data based on the DEI group (not including the DRI group). Therefore, the load of the editing processing on the browser can be reduced. In addition, the editing processing may be executed using the editing data not including the DRI group unnecessary for editing. Therefore, it is possible to reduce the probability that a defect occurs in the editing processing.

In addition, the DEI group may at least include document XML data. The DEI group may further include numbering XML data, comments XML data, and comments Extended XML data.

Accordingly, even when the support target document data in DOCX format includes an image, the image data may not be included in the DEI group. Therefore, it is possible to suppress an error caused by the image being included in the support target document data on the online editor.

In addition, the edited support target document data in DOCX format as the second document data can also be transmitted to the terminal apparatus T1.

Accordingly, the user can save the support target document data in DOCX format after the editing processing without the missing of an image file or a configuration file such as character spacing in the terminal apparatus T1 of the user.

In addition, in the editing processing, the editing data in JSON file format as the third document data displayed on the browser screen of the terminal apparatus T1 can be generated on the basis of the DEI group, and the editing data can be transmitted to the terminal apparatus T1. In addition, the editing data may be edited in response to the instruction from the terminal apparatus T1, and the edited and updated editing data may be subjected to inverse editing conversion, whereby the edited DEI group can be generated.

Accordingly, the user can execute desired editing processing with a lighter load than before by using the editing data in JSON file format based on the DEI group.

In addition, the support target document data in DOCX format before editing as the first document data and the edited support target document data in DOCX format as the second document data (that is, the document data to be saved) can be separately saved.

In addition, the DRI group as the second data group may be acquired based on identifier information transmitted from the terminal apparatus T1, and the edited support target document data (that is, the document data to be saved) in DOCX format may be generated using the acquired DEI group and the edited DEI group.

In addition, in the editing processing, an example sentence prepared in the document creation support system S can be added to the DEI group that is the first data group.

An information processing program according to the embodiment may cause a computer to achieve: acquiring first document data configured in a predetermined file format from a user terminal via a network; extracting a first data group necessary for editing processing and a second data group unnecessary for the editing processing from the first document data; executing the editing processing using the first data group; and generating second document data configured in the predetermined file format using the edited first data group and the second data group.

An information processing method according to an embodiment may include: acquiring first document data configured in a predetermined file format from a user terminal via a network; extracting a first data group necessary for editing processing and a second data group unnecessary for the editing processing from the first document data; executing the editing processing using the first data group; and generating second document data configured in the predetermined file format using the edited first data group and the second data group.

### First Modification

In the embodiment described above, the case where one user edits the editing data generated in the editing conversion processing using the terminal apparatus T1 has been exemplified. On the other hand, the editing data generated in the editing conversion processing can be edited by a plurality of users P1 to PN using a plurality of terminal apparatuses such as the terminal apparatus T1, a terminal apparatus T2, . . . , and a terminal apparatus TN. In such a case, for example, edited support target document data in DOCX format can be generated for each terminal apparatus (or for each user), and saved/managed as a different version.

### (Second Modification)

In the indent replacement processing according to the above-described embodiment, the editing processing may be executed in the user terminal T1, but may be performed in the information processing apparatus 10. In addition, the editing processing may be performed in response to the instruction of the user, but may be automatically performed in the information processing apparatus 10 or the user terminal T1, for example, without being based on the instruction of the user. In addition, in response to the editing start instruction from the terminal apparatus T1, the information processing apparatus 10 may convert the data format of the document data into, for example, JSON format, but it may be sufficient if this format conversion is performed at a timing when editing can be performed.

### (Third Modification)

In the embodiment described above, the flow of the editing processing or the like including preview screen display of the support target document has been described as an example. However, the preview screen display of the support target document is not essential, and the preview screen display of the support target document may be omitted, and the editing processing may be executed immediately after the user side receives the editing data.

### (Fourth Modification)

Some or all of the apparatuses in the above-described embodiments may be configured by hardware, or may be configured by information processing of software (program) executed by a CPU, a GPU, or the like. In addition, in the above embodiments, when a plurality of storage apparatuses stores data, each storage apparatus of the plurality of storage apparatuses may store only a part of the data or may store the entire data.

Although the embodiments of the present disclosure have been described in detail above, these embodiments have been presented as examples, and are not intended to be limited to individual embodiments. Each embodiment can be modified by various additions, changes, replacements, partial deletions, combinations, and the like without departing from the technical idea of the present invention. These embodiments and modifications thereof are included in the invention described in the patent claims and the equivalent scope thereof.

What is claimed is:

1. An information processing method comprising:
acquiring first document data configured in a predetermined file format from a user terminal via a network;
extracting a first data group necessary for editing processing and a second data group unnecessary for the editing processing from the first document data;
executing the editing processing using the first data group; and
generating second document data configured in the predetermined file format using the edited first data group and the second data group.

2. The information processing method according to claim 1, wherein
the predetermined file format is a DOCX file format.

3. The information processing method according to claim 2, wherein
the first data group at least includes document XML data.

4. The information processing method according to claim 2, wherein
the first data group further includes numbering XML data, comments XML data, and comments Extended XML data.

5. The information processing method according to claim 1, further comprising:
transmitting the second document data to the user terminal.

6. The information processing method according to claim 1, further comprising:
generating third document data for displaying on a browser screen of the user terminal based on the first data group in the editing processing; and
transmitting the third document data to the user terminal.

7. The information processing method according to claim 6, comprising:
editing the third document data in response to an instruction from the user terminal; and
generating the edited first data group based on the edited third document data.

8. The information processing method according to claim 6, wherein
the third document data is configured in a JSON file format.

9. The information processing method according to claim 1, comprising:
starting the editing processing in response to an instruction from the user terminal.

10. The information processing method according to claim 1, further comprising:
separately saving the first document data and the second document data.

11. The information processing method according to claim 1, comprising:
acquiring the second data group based on identifier information transmitted from the user terminal; and
generating the second document data using the acquired second data group and the edited first data group.

12. The information processing method according to claim 1, wherein
the editing processing includes adding an example sentence prepared in a document creation support system to the first data group.

13. An information processing apparatus comprising:
at least one processor; and
at least one memory storing instructions that, when executed by the at least one processor, cause the information processing apparatus to:
acquire first document data configured in a predetermined file format from a user terminal via a network;
extract a first data group necessary for editing processing and a second data group unnecessary for the editing processing from the first document data;
execute the editing processing using the first data group; and
generate second document data configured in the predetermined file format using the edited first data group and the second data group.

14. A non-transitory computer-readable storage medium storing instructions thereon that, when executed by a computer, cause the computer to:
acquire first document data configured in a predetermined file format from a user terminal via a network;
extract a first data group necessary for editing processing and a second data group unnecessary for the editing processing from the first document data;
execute the editing processing using the first data group; and
generate second document data configured in the predetermined file format using the edited first data group and the second data group.
